(19) United States
(12) Patent Application Publication
(10) Pub. No.: US 2007/0258184 A1
(43) Pub. Date: Nov. 8, 2007

(54) ELECTROSTATIC CHUCK OF HIGH DENSITY PLASMA DEPOSITION APPARATUS

(75) Inventor: Soo Jae Lee, Icheon-si (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hynix Semiconductor Inc., Icheon-si (KR)

(21) Appl. No.: 11/618,553

(22) Filed: Dec. 29, 2006

(30) Foreign Application Priority Data
May 2, 2006 (KR) 2006-39518

(51) Int. Cl. H01T 23/00

(52) U.S. Cl. 361/234

(57) ABSTRACT

An electrostatic chuck of a high density plasma deposition apparatus, which reduces a temperature variation in a wafer during a high density plasma deposition process to reducing peeling off of a thin film from the wafer or generation of particles on the wafer. The electrostatic chuck includes a support plate, on which a wafer is mounted by static electricity; a helium supply hole formed through the support plate for supplying helium gas to the rear surface of the wafer; a sealing protrusion formed along the edge of the support plate; and wafer lift pins formed inside a region of the support plate surrounded with the sealing protrusion.

### BACKGROUND OF THE INVENTION

The present invention relates to an electrostatic chuck of a high density plasma deposition apparatus, which reduces the temperature variation in a wafer during a high density plasma deposition process to reduce peeling of a thin film from the surface of the wafer or generation of particles on the wafer.

As semiconductor devices have become highly integrated, wire spacing has been gradually narrowed and the height of the wiring has been gradually increased. Further, the process margin in forming a device isolation film of a semiconductor substrate has been gradually decreased.

In order to solve the above problems, a process for depositing a dielectric film, such as an oxide film, using a high density plasma (HDP) deposition apparatus has been proposed. In this process, deposition of a dielectric film and etching of the dielectric film are simultaneously performed. Accordingly, this process has excellent burying characteristics compared to other conventional deposition processes, but the HDP apparatus has certain drawbacks as will be discussed below.

In order to satisfy high-speed and high-integration trends, a semiconductor device uses a thin gate dielectric film. After the thin gate dielectric film is formed, a high density plasma deposition process for burying wires is performed at a high temperature (e.g., greater than 500° C.). The high temperature of this process causes an increase in current density in the dielectric film, which surrounds a lower film, and thus causes plasma induced damage (PIDs) to the gate dielectric film through the rear surface of a wafer. This causes defects in the semiconductor device by causing changes in the breakdown voltage characteristics of the gate dielectric film.

In order to solve the above problem, a method has been used for decreasing the current density of a dielectric film and preventing PIDs by performing a high density plasma deposition process with the wafer at low temperatures (i.e., less than approximately 350° C.).

Hereinafter, a conventional electrostatic chuck of a high density plasma deposition apparatus, used in the above low temperature and high density plasma deposition process will be described in detail.

FIG. 1 is a schematic plane view of a conventional electrostatic chuck of a high density plasma deposition apparatus. FIG. 2 is an enlarged view of a section of the electrostatic chuck of FIG. 1, which contains a wafer lift pin.

With reference to FIG. 1, the conventional electrostatic chuck of the high density plasma deposition apparatus comprises a support plate 100, on which a wafer is securely mounted by static electricity. A helium supply hole 102 is formed through the support plate 100. Helium gas is supplied onto the rear surface of the wafer mounted on the support plate 100 through the helium supply hole 102. The helium gas allows the rear surface of the wafer to be kept at a low temperature of less than approximately 350° C. during the high density plasma deposition process. A sealing protrusion 104 (e.g., gasket) having a designated height is formed along the edge of the support plate 100. The sealing protrusion 104 minimizes the leakage of the helium gas supplied from the helium supply hole 102. Wafer lift pins 106 are formed on the outer region of the support plate 100 and outside the surrounding sealing protrusion 104. The wafer lift pins 106 extend normal to the surface of the support plate 100 for loading or unloading the wafer from the support plate 100.

By using the above electrostatic chuck, it is possible to perform the high density plasma deposition process with the rear surface of the wafer kept at a low temperature of less than approximately 350° C. by exposing the rear surface of the wafer to helium gas through the helium supply hole 102.

With reference to FIGS. 1 and 2, in the above electrostatic chuck, the wafer lift pins 106 are formed outside the sealing protrusion 104 of the support plate 100. Accordingly, the helium gas is blocked by the sealing protrusion 104 and does not reach the section of the support plate 100 where the wafer lift pins 106 are located.

Thereby, the high density plasma deposition process causes a condition where regions of the wafer corresponding to the sections of the support plate 100 with the wafer lift pins 106 reach a high temperature of more than 500° C., and the other regions of the wafer are kept at a low temperature of less than approximately 350° C. due to the helium gas. That is, a temperature variation occurs in the wafer during the high density plasma deposition process, which can cause various defects on the semiconductor device. The temperature variation causes a thermal stress to occur in a thin film, which causes peeling of the thin film from the surface of the wafer or generation of particles on the wafer.

### SUMMARY OF THE INVENTION

Embodiments of the present invention provide an electrostatic chuck of a high density plasma deposition apparatus, which reduces the temperature variation in a wafer during a high density plasma deposition process to reduce peeling of the thin film from the wafer and generation of particles on the wafer.

In one embodiment, an electrostatic chuck of a high density plasma deposition apparatus includes a support plate, on which a wafer is mounted by static electricity; a helium supply hole formed through the support plate for supplying helium gas to the rear surface of the wafer; a sealing protrusion formed along the edge of the support plate; and wafer lift pins formed inside the region of the support plate surrounded by the sealing protrusion.

The electrostatic chuck may further comprise embossed sections formed on the support plate for minimizing the contact surface between the rear surface of the wafer and the support plate.

The electrostatic chuck may further comprise sealing guards, each surrounding the corresponding section of the support plate with the wafer lift pins.

In one embodiment, an electrostatic chuck of a high density plasma deposition apparatus includes a support plate to support a wafer and hold the wafer using static electricity. A coolant supply hole is formed through the support plate to supply coolant to a backside of the wafer. A sealing ring is formed along the edge of the support plate, the sealing ring defining an inner region of the support plate and an outer region of the support plate. Wafer lift pins are formed within the inner region of the support plate.

### BRIEF DESCRIPTION OF THE DRAWINGS

FIG. 1 is a schematic plane view of a conventional electrostatic chuck of a high density plasma deposition apparatus;

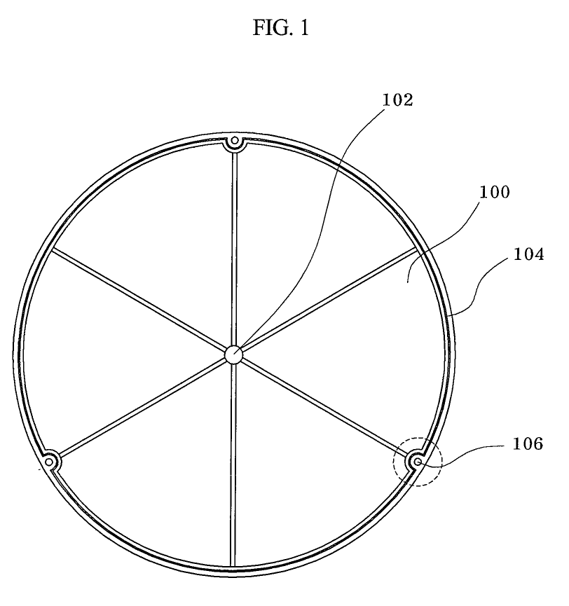

FIG. 2 is an enlarged view of a portion of the electrostatic chuck of FIG. 1, which contains a wafer lift pin;

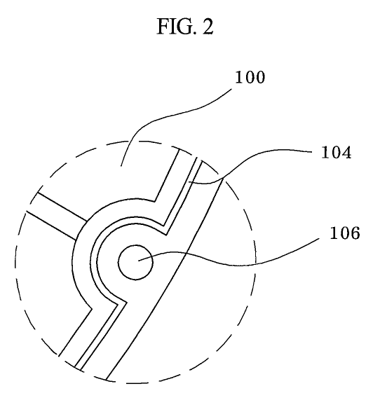

FIG. 3 is a schematic plane view of an electrostatic chuck of a high density plasma deposition apparatus in accordance with an embodiment of the present invention; and

FIG. 4 is an enlarged view of a portion of the electrostatic chuck of FIG. 3, which contains a wafer lift pin.

### DESCRIPTION OF THE EMBODIMENTS

An embodiment of the present invention will be described in detail with reference to the accompanying drawings.

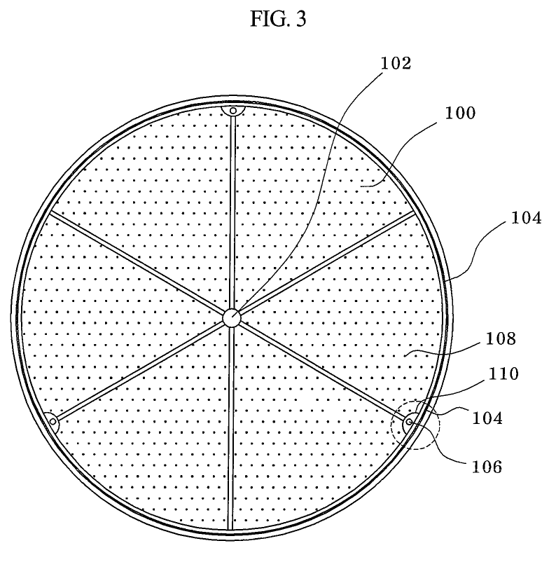

With reference to FIG. 3, an electrostatic chuck of a high density plasma deposition apparatus in accordance with an embodiment of the present invention comprises of a support plate 100, a helium supply hole 102, a sealing protrusion 104, and wafer lift pins 106.

A wafer is securely mounted on the support plate 100 by static electricity. Electric power of a designated intensity is applied to the support plate 100, and thus an electromagnetic field is formed on the support plate 100. The wafer is firmly fixed to the support plate 100 by the electromagnetic field.

A helium supply hole 102 for supplying helium gas to the rear surface of the wafer mounted on the support plate 100 is formed through the support plate 100. The helium gas serves to cool the rear surface of the wafer mounted on the support plate 100 and allows the wafer to be kept at a low temperature of less than approximately 350° C. during the high density plasma deposition process. Thereby, it is possible to decrease the current density of the gate dielectric film and to prevent plasma induced damage.

A sealing protrusion 104 having a designated height is formed along the edge of the support plate 100 of the electrostatic chuck. The sealing protrusion 104, which is formed along the edge of the support plate 100, minimizes the leakage of the helium gas, and allows the helium gas to keep the rear surface of the wafer at a low temperature.

The sealing protrusion 104 may have a small width as long as it can prevent the helium gas from leaking to the outside of the support plate 100 (e.g., 0.5 mm or less). With a small sealing protrusion width, it is possible to reduce the temperature variation in the wafer caused by the failure of the helium gas to reach the portion of the wafer contacting the sealing protrusion 104.

The sealing protrusion 104 is formed inside the edge of the support plate 100 by a small distance (e.g., 5 mm, 4 mm, 3 mm, 2 mm or less). This configuration reduces the dimensions of the region of the support plate 100 outside the sealing protrusion 104, thus reducing the temperature variation in the wafer.

Wafer lift pins 106 are formed inside the region of the support plate 100 surrounded by the sealing protrusion 104. Each of the wafer lift pins 106 passes through the corresponding lift pin holes formed through the support plate 100, and extends normal to the surface of the support plate 100. Thereby, the wafer is loaded onto or unloaded from the support plate 100. In order to reduce the leakage of the helium gas through the lift pin holes, the lift pin holes have a small diameter, but large enough to pass the wafer lift pins 106 (e.g., 2 mm or less).

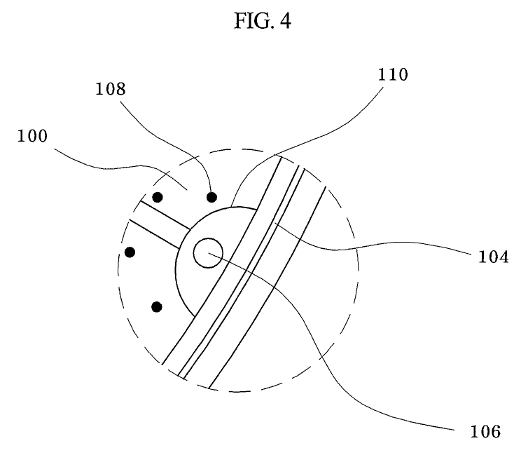

With reference to FIG. 4, in the electrostatic chuck of the high density plasma deposition apparatus of this embodiment, the wafer lift pins 106 are formed inside the region of the support plate 100 surrounded by the sealing protrusion 104, different from the conventional electrostatic chuck. Thereby, the helium gas is supplied to regions of the wafer corresponding to the sections of the support plate 100 with the wafer lift pins 106, and thus the high density plasma deposition process can be performed while maintaining a low temperature in these regions of the wafer. Accordingly, in accordance with this embodiment, it is possible to reduce the temperature variation in the wafer during the high density plasma deposition process, thus reducing peeling of a thin film from the surface of the wafer or generation of particles on the wafer, which may cause various defects to a semiconductor device.

The above-described electrostatic chuck may further comprise embossing portions 108 formed on the support plate 100. The embossing portions 108 minimize the contact surface between the rear surface of the wafer and the upper surface of the support plate 100, thus allowing the rear surface of the wafer to have maximum exposure to the helium gas.

The above-described electrostatic chuck may further comprise sealing guards 110, each of which surrounds the corresponding wafer lift pins 106. The sealing guards 110 reduce the leakage of the helium gas through the lift pin holes, into which the wafer lift pins 106 are inserted.

As apparent from the above description, the present invention provides an electrostatic chuck of a high density plasma deposition apparatus, which reduces the temperature variation in a wafer during a high density plasma deposition process to reduce peeling of a thin film from the wafer or generation of particles on the wafer, thus improving yield and reliability of the semiconductor device.

Although the embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An electrostatic chuck of a high density plasma deposition apparatus comprising:
a support plate to support a wafer and hold the wafer using static electricity;
a coolant supply hole formed through the support plate to supply coolant to a backside of the wafer;
a sealing ring formed along the edge of the support plate, the sealing ring defining an inner region of the support plate and an outer region of the support plate; and
wafer lift pins formed within the inner region of the support plate.

2. The electrostatic chuck according to claim 1, further comprising embossing portions formed on the support plate to reduce an area of the support plate contacting the backside of the wafer.

3. The electrostatic chuck according to claim 1, further comprising sealing guards, each cooperating with the sealing ring to enclose one of the wafer lift pins

4. The electrostatic chuck of claim 3, wherein each sealing guard includes two ends that are joined to respective portions of the sealing ring.

5. The electrostatic chuck of claim 3, wherein sealing guard is configured to reduce leakage of the coolant.

6. The electrostatic chuck of claim 1, further comprising a plurality of sealing guards, each being provided adjacent to one of the wafer lift pins and is configured to reduce leakage of the coolant.

7. The electrostatic chuck of claim 1, wherein the coolant is helium gas.

8. The electrostatic chuck according to claim 1, wherein the sealing ring has a width of no more than 0.5 mm.

9. The electrostatic chuck according to claim 1, wherein the sealing ring is formed at a given distance from an outer edge of the support plate, the given distance being no more than 2 mm.

10. The electrostatic chuck according to claim 1, wherein each of the wafer lift pins passes through the corresponding one of lift pin holes formed through the support plate, and each of the lift pin holes has a diameter of no more than 2 mm.
